(19) United States
(12) Patent Application Publication
(10) Pub. No.: US 2015/0058209 A1
(43) Pub. Date: Feb. 26, 2015

(54) METHOD FOR PAYMENT PROCESSING FROM ACCOUNT HOLDER TO ECOMMERCE MERCHANT

(71) Applicant: Nicholas J. Vanderlaan, Gardnerville, NV (US)

(72) Inventor: Nicholas J. Vanderlaan, Gardnerville, NV (US)

(21) Appl. No.: 14/088,175

(22) Filed: Nov. 22, 2013

Related U.S. Application Data
(63) Continuation-in-part of application No. 13/971,772, filed on Aug. 20, 2013.

(51) Int. Cl. G06Q 20/10

(52) U.S. Cl. CPC G06Q 20/102
USPC 705/40

(57) ABSTRACT

There is provided a method for payment processing from a first account holder to an ecommerce merchant. The method includes establishing a financial account with a banking institution having a bank physical location. The method further includes establishing a merchant account with the ecommerce merchant. The method further includes receiving from a merchant ecommerce server transaction order information regarding a transaction order between a first account holder and the ecommerce merchant. The transaction order information includes a transaction identifier and a specified amount. The method further includes transmitting to the first account holder identifying information regarding the financial account. The method further includes receiving from the banking institution a deposit notification of a physical deposit of currency of the specified amount at the physical location. The deposit notification includes information regarding the transaction identifier and the financial account. The method further includes crediting the merchant account by the specified amount.

### CROSS-REFERENCE TO RELATED APPLICATIONS

This patent application claims priority to and is a continuation in part patent application of U.S. patent application Ser. No. 13/971,772, filed on Aug. 20, 2013, the entire contents of which are hereby incorporated by reference.

### STATEMENT RE: FEDERALLY SPONSORED RESEARCH/DEVELOPMENT

Not Applicable

### BACKGROUND

1. Technical Field

The present disclosure relates generally to a method for payment, and more particularly, to a method for payment processing from an account holder to an ecommerce merchant.

2. Related Art

Electronic commerce or ecommerce is a common form of engaging customers and merchants for the sale of goods and services over a computer network, most typically the Internet. Payment for goods and services with an ecommerce merchant typically involves the transfer of monetary amounts from one financial account to another. This may include use of credit cards, debit cards, charge cards, and the like. Such payment types offer different conveniences to the user, but commonly, these payment methods provide the ecommerce merchant with a relatively fast method of receiving funds. Other payment types include personal checks and cashier's checks, and bank wire transfers. Such payment methods have inherent delays in finalizing the transaction, as the ecommerce merchant has to wait for the arrival of the check or confirmation of the bank wire. Also with most all of the above payment methods, there are a number of associated fees charged that are incurred by the customer and/or the ecommerce merchant. Nonetheless all of the above payment methods facilitate an online customer experience and the associated convenience of the automated purchase process in just a matter of computer mouse clicks. Merchants similarly benefit, the merchant is able to receive payment without receiving cash payment and the associated risk of theft and robbery.

A common characteristic of all such payment methods is that there is an electronic record directly correlated to the customer or at least the customer's financial account originating the electronic payment to the ecommerce merchant. However, there are some ecommerce customers that would prefer a higher degree of anonymity with regard to their purchases and/or origin of funds to pay for such purchases. Furthermore, those suspicious of governmental over-reach with regard to individual privacy rights may desire to mitigate or otherwise minimize the amount of information that may be discovered regarding personal business activities and financial accounts and the like.

In addition, another topic of concern is related to privacy issues. In this regard, most all of the various online payment options discussed above include some form of financial account of the online customer (such as their credit card issuer or bank). As account information is necessarily provided to the ecommerce merchant, there is a risk and legitimate concern related to third parties improperly gaining access to such account information. Computer “hackers” who illegally gain access to such account information are responsible for a constant legitimate threat of credit card fraud. This is despite ongoing advances in computer security.

Therefore, there exists a need for an improved payment method in comparison to the prior art.

### BRIEF SUMMARY

In accordance with one embodiment of the present disclosure, there is contemplated a method for payment processing from a first account holder to an ecommerce merchant. The method includes establishing a financial account with a banking institution. The banking institution has a bank physical location. The method further includes establishing a merchant account, via an online computer network, with the ecommerce merchant. The method further includes receiving from a merchant ecommerce server, via an online computer network, transaction order information regarding a transaction order between a first account holder and the ecommerce merchant. The transaction order information includes a transaction identifier and a specified amount. The method further includes transmitting to the first account holder, via an online computer network, identifying information regarding the financial account. The method further includes receiving from the banking institution a deposit notification of a physical deposit of currency of the specified amount at the physical location. The deposit notification includes information regarding the transaction identifier and the financial account. The method further includes crediting the merchant account by the specified amount.

The foregoing method advantageously facilitates physical payment of currency in the context of an ecommerce transaction. The method allows for the convenience, timing, and efficiency associated with online transactions while permitting the flexibility of allowing the customer (i.e., the first account holder) to be able to make a cash payment. It is contemplated that large banking institutions have a myriad of physical locations. This allows for the ecommerce customer to conveniently make the physical deposit of currency at any of such physical locations. Associated with such cash deposit is the anonymity of currency. This is unlike other forms of payment with their associated information and inherent traceability. Moreover, other forms of payment may also be susceptible to fraud as the associate transaction information or account information may fall to the wrong hands. Additionally, certain fees associated with some non-cash payment options may be avoided that are incurred by the customer (such as fees for cashier's checks or bank wire fees) or by the ecommerce merchant (such as credit card processing fees). Further, the method allows for a third party payment processing service to interact with or otherwise handle establishing various banking relationships to facilitate payment at a choice of a number of banking institutions without the ecommerce merchant having to do so. Rather, the ecommerce merchant need only electronically interact with the third party payment processing service to obtain such benefits. This can readily be facilitated through the inclusion of a software widget at the ecommerce merchant website that makes calls from and to a webserver of the third party payment processing service.

According to various embodiments, the transmitting to the first account holder identifying information regarding the financial account may include identifying the account number with the banking institution. The transmitting to the first account holder identifying information regarding the financial account may include identifying the bank physical location. The transmitting to the first account holder identifying information regarding the financial account may be via the merchant ecommerce server. The method may further include transmitting to the first account holder a listing of banking institutions, and the listing includes the banking institution. The transmitting of the listing of banking institutions may be via the merchant ecommerce server. The method may further include receiving from the first account holder, via a computer network, a selection of the banking institution. The receiving of the selection of the banking institution may be via the merchant ecommerce server. The method may further include transmitting to the first account holder, via an online computer network, the transaction identifier. The method may further include receiving the deposit notification via an online computer network. The method may further include providing payment to the ecommerce merchant in the amount of the specified amount. The payment may be made via a bank check. The establishing of the merchant account, via an online computer network, with the ecommerce merchant may be with a payment processing server. The receiving from a merchant ecommerce server, via an online computer network, the transaction order information may be by the payment processing server. The method may further include establishing a payment account, via an online computer network, with the first account holder with the payment processing server.

According to another embodiment, there is provided a method for payment processing from a first account holder to an ecommerce merchant. The method includes establishing a financial account with a banking institution, the banking institution having a bank physical location. The method further includes establishing a merchant account, via an online computer network, with the ecommerce merchant with a payment processing server. The method further includes receiving by a payment processing server from a merchant ecommerce server, via an online computer network, transaction order information regarding a transaction order between a first account holder and the ecommerce merchant. The transaction order information includes a transaction identifier and a specified amount. The method further includes transmitting from the payment processing server to the first account holder, via an online computer network, identifying information regarding the financial account. The method further includes receiving by the payment processing server from the banking institution a deposit notification of a physical deposit of currency of the specified amount at the physical location. The deposit notification includes information regarding the transaction identifier and the financial account. The method further includes crediting the merchant account by the specified amount. The method may further include establishing a payment account with the first account holder with the payment processing server.

### BRIEF DESCRIPTION OF THE DRAWINGS

These and other features and advantages of the various embodiments disclosed herein will be better understood with respect to the following description and drawings, in which:

FIG. 1 is a symbolic block diagram illustrating an exemplary environment in which one embodiment of the present disclosure may be implemented;

FIG. 2 is a flow chart of steps according to an aspect of the present invention;

FIG. 3 is a symbolic block diagram illustrating an exemplary environment in which another embodiment of the present disclosure may be implemented; and

FIG. 4 is a flow chart of steps according to another aspect of the present invention.

Common reference numerals are used throughout the drawings and the detailed description to indicate the same elements.

### DETAILED DESCRIPTION

The detailed description set forth below in connection with the appended drawings is intended as a description of certain embodiments of the present disclosure, and is not intended to represent the only forms that may be developed or utilized. The description sets forth the various functions in connection with the illustrated embodiments, but it is to be understood, however, that the same or equivalent functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

A method for payment from a first account holder to an ecommerce merchant is contemplated in accordance with various embodiments of the present disclosure. Generally, the method provides for use of a financial account of the merchant with a banking institution having a bank physical location. Additional details of this method will be discussed below.

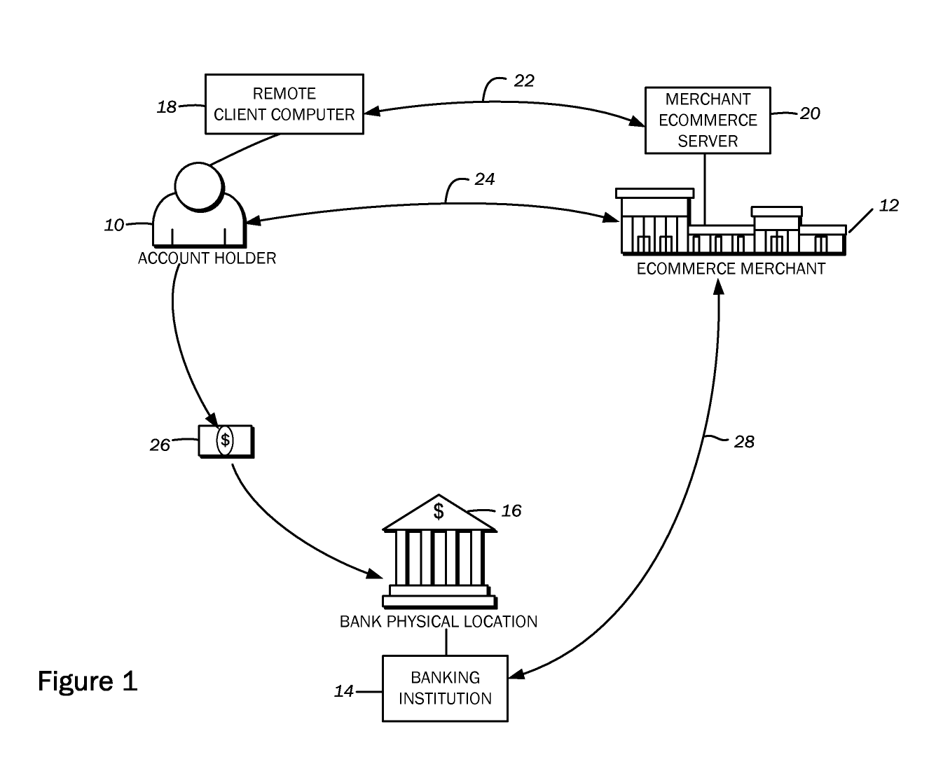

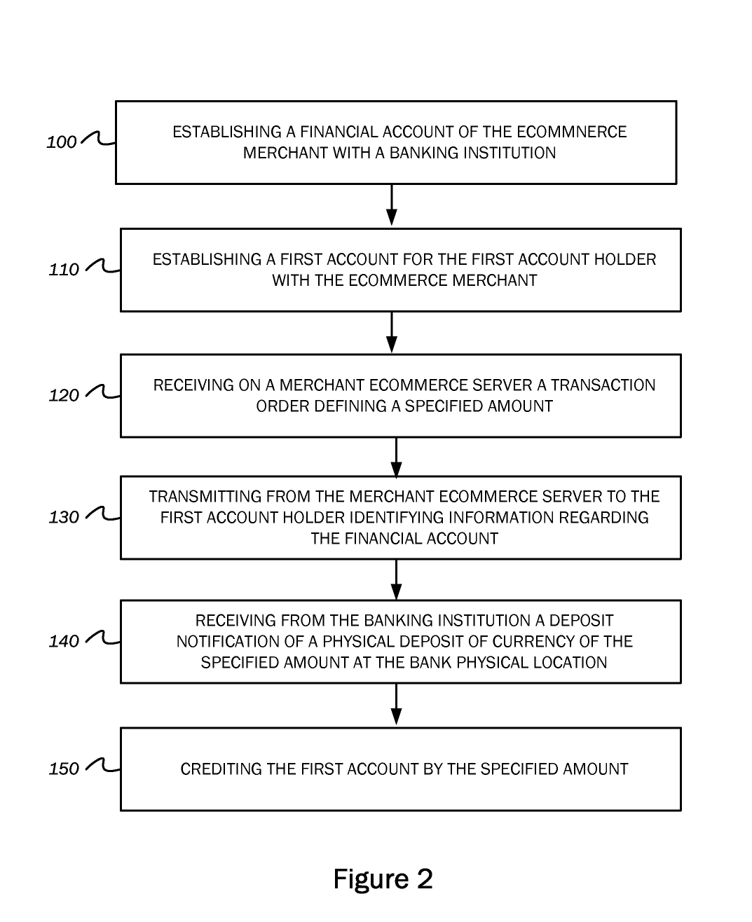

FIG. 1 is a symbolic block diagram illustrating an exemplary environment in which one embodiment of the present disclosure may be implemented. FIG. 1 symbolically illustrates pertinent relationships between various entities involved in the method of payment by a first account holder 10 to an ecommerce merchant 12 in accordance with an aspect of the present invention. The method contemplates that the ecommerce merchant 12 has an associated banking institution 14. The banking institution 14 has a bank physical location 16. Referring additionally to FIG. 2, there is provided a flowchart of steps according to an aspect of the present invention.

The method of payment initially includes step 100 of establishing a financial account of the ecommerce merchant 12 with the banking institution 14. The method further includes step 110 of establishing a first account for the first account holder 10 with the ecommerce merchant 12. The method further includes step 120 of receiving on a merchant ecommerce server 20, via an online computer network, a transaction order related to the first account from a remote client computer 18 associated with the first account holder 10. The transaction order defines a specified amount. The method further includes step 130 of transmitting from the merchant ecommerce server 20, via an online computer network, to the first account holder 10 identifying information regarding the financial account. The method further includes step 140 of receiving from the banking institution 14 a deposit notification of a physical deposit of currency 26 of the specified amount at the bank physical location 16. The deposit notification includes information regarding the first account and the financial account. The method further includes step 150 of crediting the first account by the specified amount.

As will be next discussed are various definitional understandings with regard to terminology used to articulate the methods in accordance with aspect of the inventions disclosed herein. As used herein the first account holder 10 may be an individual or any legal entity, such as a corporation. Similarly, as used herein the ecommerce merchant 12 may be an individual or any legal entity, such as a corporation. As used herein the term banking institution 14 refers to any financial institution that provides financial services to its clients or members. Typically the banking institution 14 would be regulated by a governmental entity, and may include banks, credit unions, trust companies, and any financial intermediary that accept deposits of currency.

As used herein bank physical location 16 refers to any physical location that is owned, controlled or used by the banking institution 14 that is equipped to accept a physical deposit of currency 26 or any physical location where a representative or agent of the banking institution 14 happens to be that is authorized to accept a physical deposit of currency 26. In this regard, the bank physical location may be a bank branch (typically a permanent retail presence of the banking institution 14), automated teller machine (ATM), kiosk, or even a mobile location (such as a vehicle).

As further used herein the remote client computer 18 refers to any computing device capable of electronically communicating with a computer network and is, directly or indirectly, owned, controlled or otherwise used by or on behalf of the first account holder 10. The remote client computer 18 may be one or more devices, and may be a desktop computer, laptop, terminal, mobile device (such as a tablet device or smart phone), as examples.

As used herein the merchant ecommerce server 20 refers to any computing device capable of electronically communicating with a computer network and is, directly or indirectly, owned, controlled or otherwise used by or on behalf of the ecommerce merchant 12. The merchant ecommerce server 20 may be one or more devices, and may be a server, workstation, computer array, desktop computer, laptop, terminal, or even a mobile device (such as a tablet device or smart phone), as examples.

As used herein currency 26 refers to physical money, as a medium of exchange, especially circulating paper money and coins, as issued by a governmental entity. In this regard, currency 26 would not include checks, cashier's checks, certificates of deposit, or securities. Rather, currency 26 is what a lay person would simply understand as “cold hard cash.” Currency is not singly tied or associated with any financial institution, other than the issuing governmental entity. In the United States, currency 26 would be understood to be actual United States dollars and coins. As such, currency 26 has an inherent anonymity associated with it.

As discussed above, the method of payment initially includes step 100 of establishing the financial account of the ecommerce merchant 12 with the banking institution 14. The establishing of the financial account may include providing the identity of the ecommerce merchant 14 such as by name and/or governmental identification number (such as a taxpayer identification number), and contact information such as telephone numbers, mailing address and email address. As indicated in FIG. 1, there is provided a symbolic link 28 that is used to symbolically indicate the general interaction between the ecommerce merchant 12 and the banking institution 14. This step 100 of establishing the financial account may be done via any means, such as in person, correspondence, email, telephonically or online.

The step 110 of establishing the first account for the first account holder 10 with the ecommerce merchant 12 is next provided. As indicated in FIG. 1, there is provided a symbolic link 24 that is used to symbolically indicate the general interaction between the first account holder 10 and the ecommerce merchant 12. This step of establishing the first account may be done via any means, such as in person, correspondence, email, telephonically or online. However, conveniently, the first account may be established via an online computer network.

The first account holder 10 may use the remote client computer 18 to interact with the merchant ecommerce server 20 via the electronic communications link 28. The remote client computer 18 may be used to connect to the online computer network, such as the Internet, to interact with a website that may be associated with or otherwise included in the merchant ecommerce server 20. As is the case with most computer website systems configured to serve web pages, a base operating system may be running thereon. The operating system may manage one or more server applications including a HyperText Transfer Protocol (HTTP) server, that may be included in the merchant ecommerce server 20 that receives requests (in the form of Uniform Resource Identifiers (URIs) for a specific HyperText Markup Language (HTML) document, and transmits that document back to the requestor. Additional data included in those pages, as well as account-related data, may be retrieved from a related database. The account setup may be specifically implemented as a series of instructions executable by an application server that generates outputs produced as web pages by the HTTP server. The electronic communications link 28 may be used to pass data between the remote client computer 18 and such HTTP server associated with the merchant ecommerce server 20. Although a specific implementation of a HTTP server is described herein, it is not intended to be limiting, and other implementations may be substituted.

The establishing of the first account may include providing the identity of the first account holder 10 such as by name and/or governmental identification number (such as a taxpayer identification number), and contact information such as telephone numbers, mailing address and email address. However, a unique client identifier may be used. This may take the form of just an account name or ID (which the first account holder 10 may provide, which may be a made up name or series of alpha-numeric symbols).

The method next provides for the step of 120 receiving on the merchant ecommerce server 20 the transaction order defining the specified amount. In this regard, it is contemplated that the transaction order may be any request for the provisioning of goods or services in exchange for monetary consideration defining the specified amount or otherwise understood as an order or an acceptance of an offer of an ecommerce transaction. This may be effectuated via the HTTP server described above wherein the first account holder 10 may utilize the remote client computer 18 to interact with a website place an ecommerce order. As such, in order to complete the transaction or sale, it is contemplated that payment would need to be made from the first account holder 10 to the ecommerce merchant 12.

The method of payment discussed above further contemplates the step 130 of transmitting from the merchant ecommerce server, via an online computer network, to the first account holder 10 identifying information regarding the financial account. This may be accomplished via various methods. For example, this may be effectuated in the form of a screen display, an email, a text message, a computer generated telephone voice message, or an electronic message accessed via an online account associated with the first account.

In the case where the first account holder 10 has interacted with a website to generate the transaction order, the ecommerce merchant server 20 may generate a communication to the first account holder 10 in the form of a screen message that includes instructions for the first account holder 10 to make a payment in the specified amount by physically depositing currency 26 with the banking institution 14 at the bank physical location 16 using the identifying information regarding the financial account. Additional communications may be made so as to confirm the information of the screen message. For example, a confirmation email may be generated by the merchant ecommerce server 20 and sent via the electronic link 22 and accessed by the remote client computer 18.

It is contemplated that many large banking institutions have numerous physical locations that may be relatively convenient for customers of the ecommerce merchant 12 to physically make a deposit of currency 26 so as to make payment to the ecommerce merchant 12, thereby completing the associated transaction. The identifying information regarding the financial account may be used by the banking institution 14 to correlate any deposit made by the first account holder 10 with the financial account of the ecommerce merchant 12. The identifying information may include the account number or other information that may be used to derive the identification of the financial account, such as the identity of the ecommerce merchant 12. To this end, the method of payment further provides the step 140 of receiving from the banking institution 14 a deposit notification of a physical deposit of currency 26 of the specified amount at the bank physical location 16. The deposit notification includes information regarding the first account and the financial account.

The information regarding the first account may include a transaction identifier associated with the transaction order. The information regarding the first account may include an account name associated with the first account. It is contemplated that the first account holder 10 provides information to the banking institution 14, at the time of making the physical deposit of currency 26, this form of information would eventually enable the ecommerce merchant 12 to correlate the deposit with the first account of the first account holder 10.

The deposit notification may be received via an online computer network. For example, the banking institution 14 may send an email communication via the symbolic link 28 to the ecommerce merchant 12 as processed via the merchant ecommerce server 20. For another example, the ecommerce merchant 12 may interact with a website of the banking institution 14 to receive electronic messages related to the financial account.

The method of payment may further include receiving from the first account holder 10 a notification of a physical deposit of currency 26 of the specified amount at the bank physical location 16. This notification may include information regarding the first account and the financial account, such as account numbers or account names. This notification from the first account holder 10 may be received via an online computer network. As such, the notification from the first account holder 10 may be received via an email communication or other electronic communication via the symbolic link 22. In this regard, the notification from the first account holder 10 may be used to prompt the ecommerce merchant 12 to verify or confirm the deposit with the banking institution 14 thereby initiating the receipt of the deposit notification.

Thus, having confirmation from the banking institution 14 through receipt of the deposit notification, the method of payment continues with the step 150 of crediting the first account by the specified amount. The method may further include transmitting from the merchant ecommerce server 20, via an online computer network, to the first account holder 10 a confirmation of the first account having been credited. This may be an email or other electronic communication.

The foregoing method advantageously facilitates physical payment of currency in the context of an ecommerce transaction. The method allows for the convenience, timing, and efficiency associated with online transactions while permitting the flexibility of allowing the customer (i.e., the first account holder) to be able to make a cash payment. It is contemplated that large banking institutions have a myriad of physical locations. This allows for the ecommerce customer (i.e., the first account holder 10) to conveniently make the physical deposit of currency 26 at any of such physical locations (i.e., the bank physical location 16). Associated with such cash deposit is the anonymity of currency 26. This is unlike other forms of payment with their associated information and inherent traceability. Moreover, other forms of payment may also be susceptible to fraud as the associate transaction information or account information may fall to the wrong hands. Additionally, certain fees associated with some non-cash payment option may be avoided that are incurred by the customer (such as fees for cashier's checks or back wire fees) or by the ecommerce merchant (such as credit card processing fees).

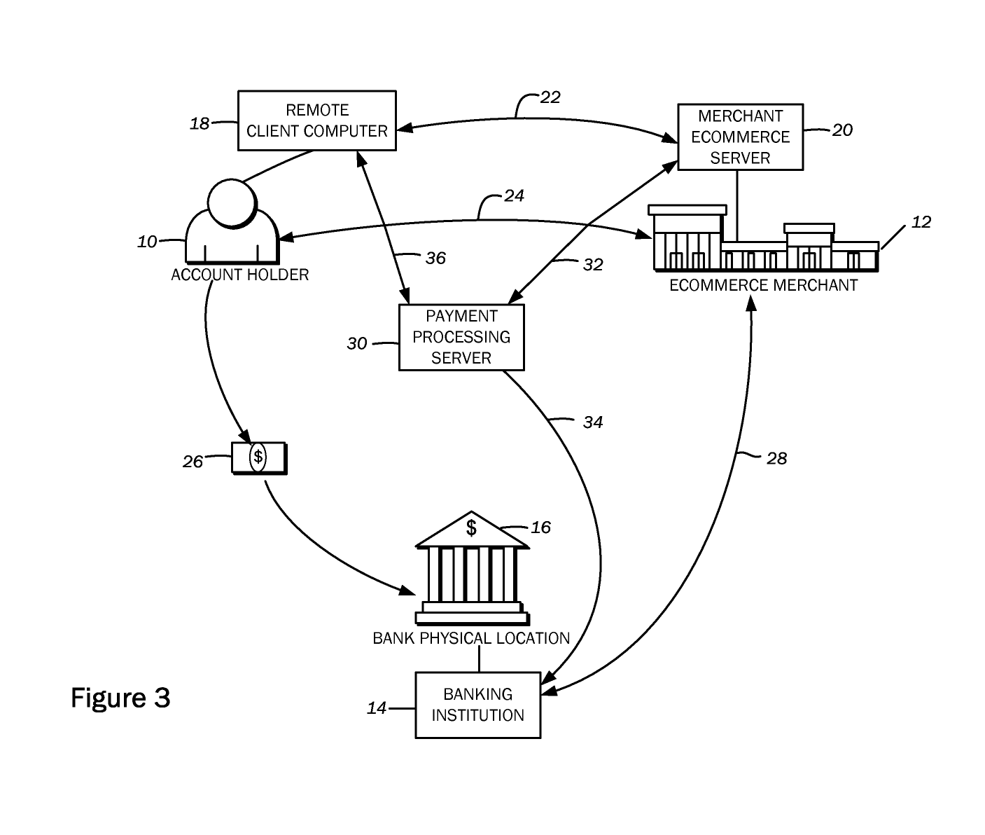

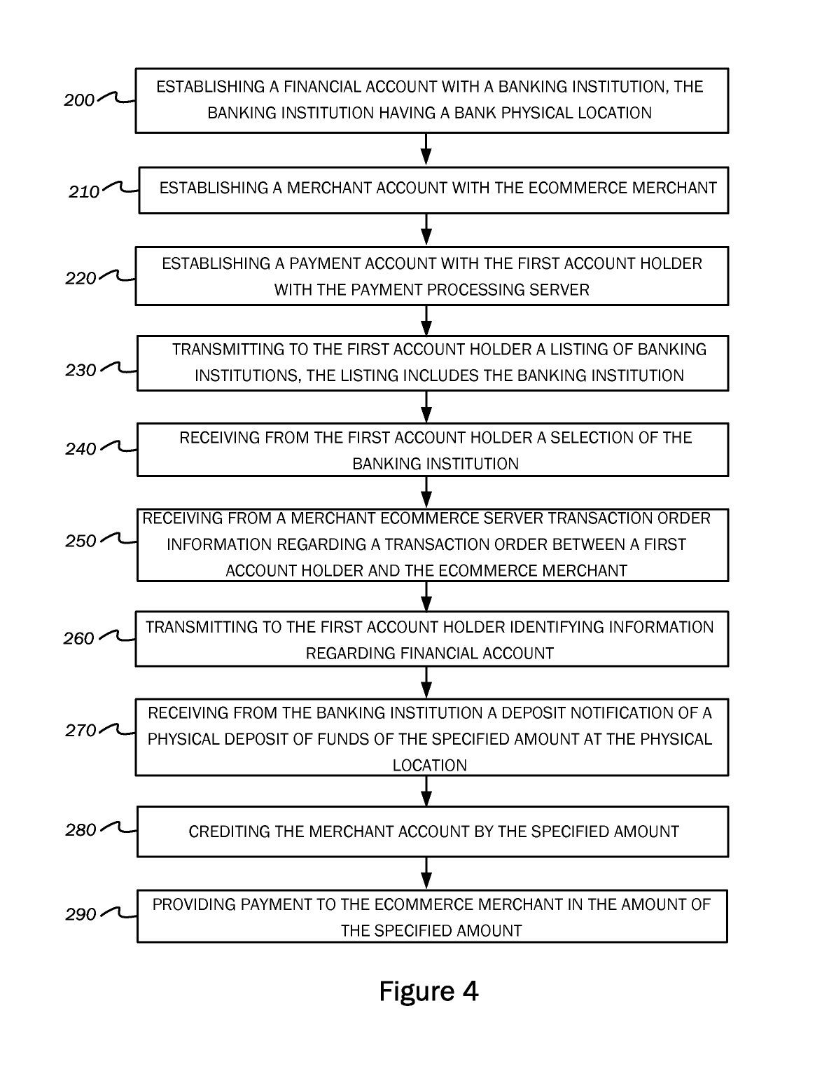

Referring now to FIG. 3, there is provided a symbolic block diagram illustrating an exemplary environment in which another embodiment of the present disclosure may be implemented. Like reference numerals indicate like elements and steps. Thus, similar referenced elements and steps are as described above but with those differences noted. FIG. 3 symbolically illustrates pertinent relationships between various entities involved in the method of payment processing by the first account holder 10 to the ecommerce merchant 12 in accordance with another aspect of the present invention. Referring additionally to FIG. 4, there is provided a flowchart of steps according to an aspect of the present invention as implemented in the exemplary environment as illustrated in FIG. 3. In this regard, the below described methodology may be implemented through the use of a payment processing server 30.

In accordance with another embodiment of the present disclosure, there is contemplated a method for payment processing from the first account holder 10 to the ecommerce merchant 12. The method includes step 200 of establishing a financial account with a banking institution, such as the banking institution 14. The banking institution 14 has a bank physical location 16. The method further includes step 210 of establishing a merchant account, via an online computer network, with the ecommerce merchant 12. The method further includes step 250 of receiving from a merchant ecommerce server 20, via an online computer network, transaction order information regarding a transaction order between a first account holder 10 and the ecommerce merchant 12. The transaction order information includes a transaction identifier and a specified amount. The method further includes step 260 of transmitting to the first account holder 10, via an online computer network, identifying information regarding the financial account. The method further includes step 270 of receiving from the banking institution 14 a deposit notification of a physical deposit of currency 26 of the specified amount at the physical location 16. The deposit notification includes information regarding the transaction identifier and the financial account. The method further includes step 280 of crediting the merchant account by the specified amount.

It is initially contemplated that the first account holder 10 may have entered into a transaction order (i.e., an online purchase) with the ecommerce merchant 12 via the electronic communications link 22 between the remote client computer 18 and the merchant ecommerce server 20. The transaction order would require payment from the first account holder 10 to the ecommerce merchant 12.

As mentioned above, the method includes step 200 of establishing the financial account with the banking institution 14. The banking institution 14 has a bank physical location 16. The financial account may be owned or controlled by a service provider controlling the payment processing server 30. It is contemplated that such service provider may have numerous banking relationships with various other banking institutions with one or more physical locations and associated financial accounts. The establishing of the financial account may include providing the identity of the service provider controlling the payment processing server 30 such as by name and/or governmental identification number (such as a taxpayer identification number), and contact information such as telephone numbers, mailing address and email address. This step 200 of establishing the financial account may be done via any means, such as in person, correspondence, email, telephonically or online.

As mentioned above, the method further includes step 210 of establishing a merchant account, via an online computer network, with the ecommerce merchant 12. The step 210 of establishing of the merchant account, via an online computer network, with the ecommerce merchant 12 may be with the payment processing server 30. This may be accomplished by establishing an electronic communications link 32 between the payment processing server 30 and the merchant ecommerce server 20 of the ecommerce merchant 12. The electronic link 32 may be facilitated through the inclusion of a software widget at the merchant ecommerce server 20 that makes calls from and to the payment processing server 20.

The method may further include a step 220 of establishing a payment account, via an online computer network, with the first account holder 10 with the payment processing server 30. The first account holder 10 may use the remote client computer 18 to interact with the payment processing server 30 via an electronic communications link 36. Alternatively, such payment account may be facilitated through the passage of information between the remote client computer 18 and the payment processing server 30 via the electronic communications link 22 between the remote client computer 18 and the merchant ecommerce server 20 and the electronic communications link 32 between the merchant ecommerce server 20 and the payment processing server 30. This may be done in connection with the particular transaction order with the ecommerce merchant 12 or at some point prior. Furthermore, the payment account may be of a specific transaction based relationship (such as a “guest account”) or more formalized with the first account holder 10 having a set up process that includes a login and password. The payment account set up may include provision of an email address of the first account holder 10 and certain payment preferences, such as desired banking institutions to which the first account holder 10 may prefer to transact with. In this regard, the payment processing server 30 is contemplated to similar arrangements with numerous ecommerce merchants, in addition to the ecommerce merchant 12. The payment processing methodologies contemplated herein may facilitate the first account holder 10 to readily transact ecommerce with many ecommerce merchants, in addition to ecommerce merchant 12, who also offer the ability to make payments utilizing the payment process server 30. In this regard, the first account holder 10 may have an established payment account with the payment processing server 30. Upon entering into an online transaction with the website that offers a payment option of utilizing the services of a payment service provider operating the payment processing server 30, the first account holder 10 may efficiently make such transaction as some of the information of the first account holder 10 is already associated with the payment account.

The method may further include a step 230 of transmitting to the first account holder 10 the listing of banking institutions, and the listing includes the banking institution 14. The transmitting of the listing of banking institutions may be via the merchant ecommerce server 30. In this regard, the listing may be transmitted to the first account holder 10 through the merchant ecommerce server 20. In such a case, the merchant ecommerce server 20 would be envisioned to make a system call to the payment processing server 30 using the electronic communications link 32. The payment processing server 30 would respond by transmitting to the merchant ecommerce server 30 the listing of banking institutions using the electronic communications link 32. The merchant ecommerce server 30 would then complete the step 230 of transmitting to the first account holder 10 the listing of banking institutions using the electronic communications link 22. It is contemplated that the service provider controlling the payment processing server 30 would have financial accounts established with each of the banking institutions of the listing.

The merchant ecommerce server 20 may be programmed to enable the website of the ecommerce merchant 12 to present the first account holder 10 with the listing in any format. From a user experience point of view, the listing may be arranged in a “drop down menu” or a “map view” displaying physical locations of the banking institutions in relation to a digital geographical map, for examples. It is contemplated that the payment account may include information pertaining to banking institutions associated with the first account holder 10. This may be those banking institutions which the first account holder 10 also has a banking account, those which have locations “preferred” by the first account holder 10, and/or those which the first account holder 10 has already been associated with in relation to past transactions, as examples. In such a case, the listing of the banking institutions may include a highlighting of any of those banking institutions already associated with the first account holder 10.

The method may further include the step 240 of receiving from the first account holder 10, via a computer network, a selection of the banking institution 14. The receiving of the selection of the banking institution 14 may be via the merchant ecommerce server 20. The first account holder 10 may use the remote client computer 18 to communicate the selection to the merchant ecommerce server 20 using the electronic communications link 22. Subsequently, the merchant ecommerce server 20 may communicate the selection to the payment processing server 30 using the electronic communications link 32 with the merchant ecommerce server 20. Alternatively, the selection of the banking institution 14 may be made directly to the payment processing server 30 using the electronic communications link 26 with the remote client computer 18. This may be in the context of the listing being presented to the account holder 10 also directly from the payment processing server 30 using the electronic communications link 26 with the remote client computer 18.

As mentioned above, the method further includes step 250 of receiving from the merchant ecommerce server 20, via an online computer network, transaction order information regarding a transaction order between a first account holder 10 and the ecommerce merchant 12. In this regard, the transaction order information may be received by the payment processing server 30 using the electronic communications link 32. The step 250 of receiving may take various electronic forms, such as a screen message in the case of a website interaction, an email, or an email which includes electronic links to establish the electronic communications link 22 as examples.

The transaction order includes certain transaction order information. This may include a transaction identifier and a specified amount. The transaction identifier may be a unique purchase order number as provided by the merchant ecommerce server 20. The specified amount would correlate to a monetary amount of the transaction that is owed to the ecommerce merchant 12. This may be the entire monetary amount of the transaction or a portion thereof. Other pertinent information regarding the transaction order information may include a date/time stamp of the transaction, the name associated with first account holder 10 making the transaction, and the nature of the goods/services purchased.

As mentioned above, the method further includes step 260 of transmitting to the first account holder 10, via an online computer network, identifying information regarding the financial account. The identifying information may be transmitted in various forms. For example, this may be effectuated in the form of a screen display, an email, a text message, a computer generated telephone voice message, or an electronic message accessed via an online account associated with the first account. In one embodiment, it may take the form of an email sent from the payment processing server 30 and received by the remote client computer 18. In another form a “message” associated with the payment account of the first account holder 10 using the electronic communications link 36 between the payment processing server 30 and the remote client computer 18. The identifying information may come directly from the payment processing server 30 to the remote client computer 18 using the electronic communications link 36, or indirectly from the merchant ecommerce server 20 to the remote client computer 18 using the electronic communications link 22 where the merchant ecommerce server 20 had previously obtained the identifying information regarding financial account from a system call to the payment processing server using the electronic communications link 32.

The identifying information regarding the financial account may include the account number or other information that may be used to derive the identification of the financial account, such as the identity of the entity associated with the payment processing server 30. The identifying information regarding the financial account may be used by the banking institution 14 to correlate any deposit made by the first account holder 10 with the financial account of the ecommerce merchant 12. Other information regarding the financial account may include identifying the banking institution 14 and the associated bank physical location 16. The method may further include transmitting to the first account holder 10, via an online computer network, the transaction identifier. Whether directly from the payment processing server 30 or indirectly from the merchant ecommerce server 20 a communication is generated and transmitted to the first account holder 10 that includes instructions for the first account holder 10 to make a payment in the specified amount by physically depositing currency 26 with the banking institution 14 at the bank physical location 16 using the identifying information regarding the financial account.

Having been informed regarding the bank physical location 16 and identifying information regarding the financial account, the first account holder 10 is contemplated to make a physical deposit of currency 26 at the bank physical location 16. At the least, the first account holder 10 needs to know the location of the bank physical location 16 (or at least information to derive it), the specified amount, and be able to provide the banking institution 14 with some form of information that would enable the banking institution 14 to correlate a deposit made by the first account holder 10 with the financial account of the entity associated with the payment processing server 30 (which may just be the account number). In addition, the first account holder 10 also needs to provide the banking institution 14 with information that would allow the payment processing server 30 to be able to correlate the deposit of funds with transaction order. This may take the form of the transaction identifier or identifying information of the first account holder 10, such as information from the payment account.

As mentioned above, the method further includes step 270 of receiving from the banking institution a deposit notification of a physical deposit of currency 26 of the specified amount at the physical location 16. The deposit notification includes information regarding the transaction identifier and the financial account. The method may further include receiving the deposit notification via an online computer network. In this regard, the payment processing server 30 may use an electronic communications link 34 with the banking institution 14 to receive the deposit notification. The method of payment may further include receiving from the first account holder 10 a notification of a physical deposit of currency 26 of the specified amount at the bank physical location 16. This notification may include information regarding the first account holder 10 and the financial account, such as account numbers or account names. This notification from the first account holder 10 may be received via an online computer network. As such, the notification from the first account holder 10 may be received via an email communication or other electronic communication via the electronic communications link 36. In this regard, the notification from the first account holder 10 may be used to prompt the payment processing server 34 to verify or confirm the deposit with the banking institution 14 thereby initiating the receipt of the deposit notification.

Thus, having confirmation from the banking institution 14 through receipt of the deposit notification, the method of payment continues with the step 280 of crediting the merchant account by the specified amount. The method may further include transmitting from the merchant ecommerce server 20, via an online computer network, to the first account holder 10 a confirmation of the merchant account having been credited. This may be an email or other electronic communication. The payment processing server 30 may generate a further confirmation or acknowledgement of the deposit to the first account holder 10.

The method may further include the step of providing 290 payment to the ecommerce merchant 12 in the specified amount. The payment may be made via a bank check which may simply be sent via hardcopy mail. It is contemplated that the out of pocket transactional cost of crediting the ecommerce merchant 12 may thus be essentially the cost of postage. Other forms and manner of payment may be utilized. For example, the banking institution 14 may be instructed to generate a payment to the ecommerce merchant 12 such as via an online check to the ecommerce merchant 12. A symbolic link 28 is indicated to represent communication between the ecommerce merchant 12 and the banking institution 14. This may be via electronic communication or otherwise. In another example, to the extent that both the entity associated with the payment processing server 30 and the ecommerce merchant 12 commonly share banking relationships with the same banking institution 14, an intrabank transfer from one account to another account may be effectuated. However, it is contemplated that the ecommerce merchant 12 and the payment from the entity associated with the payment processing server 30 would work out a payment methodology that takes into consideration transactional costs and timing of the payment being made.

The particulars shown herein are by way of example only for purposes of illustrative discussion, and are presented in the cause of providing what is believed to be the most useful and readily understood description of the principles and conceptual aspects of the various embodiments set forth in the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A method for payment processing from a first account holder to an ecommerce merchant, the method comprising:
establishing a financial account with a banking institution, the banking institution having a bank physical location;
establishing a merchant account, via an online computer network, with the ecommerce merchant;
receiving from a merchant ecommerce server, via an online computer network, transaction order information regarding a transaction order between a first account holder and the ecommerce merchant, the transaction order information including a transaction identifier and a specified amount;
transmitting to the first account holder, via an online computer network, identifying information regarding financial account;
receiving from the banking institution a deposit notification of a physical deposit of currency of the specified amount at the physical location, the deposit notification including information regarding the transaction identifier and the financial account; and
crediting the merchant account by the specified amount.

2. The method of claim 1 wherein the transmitting to the first account holder identifying information regarding the financial account includes identifying an account number with the financial banking institution.

3. The method of claim 2 wherein the transmitting to the first account holder identifying information regarding the financial account includes identifying the bank physical location.

4. The method of claim 1 wherein the transmitting to the first account holder identifying information regarding the financial account is via the merchant ecommerce server.

5. The method of claim 1 further includes:
transmitting to the first account holder a listing of banking institutions, the listing includes the banking institution.

6. The method of claim 5 wherein the transmitting of the listing of banking institutions is via the merchant ecommerce server.

7. The method of claim 5 further includes:
receiving from the first account holder, via a computer network, a selection of the banking institution.

8. The method of claim 7 wherein the receiving of the selection of the banking institution is via the merchant ecommerce server.

9. The method of claim 1 further includes transmitting to the first account holder, via an online computer network, the transaction identifier.

10. The method of claim 1 includes:
receiving the deposit notification via an online computer network.

11. The method of claim 1 further includes:
providing payment to the ecommerce merchant in the amount of the specified amount.

12. The method of claim 11 wherein the payment is made via a bank check.

13. The method of claim 1 wherein the establishing of the merchant account, via an online computer network, with the ecommerce merchant is with a payment processing server.

14. The method of claim 13 wherein the receiving from a merchant ecommerce server, via an online computer network, the transaction order information is by the payment processing server.

15. The method of claim 13 further includes:
establishing a payment account, via an online computer network, with the first account holder with the payment processing server.

16. A method for payment processing from a first account holder to an ecommerce merchant, the method comprising:
establishing a financial account with a banking institution, the banking institution having a bank physical location;
establishing a merchant account, via an online computer network, with the ecommerce merchant with a payment processing server;
receiving by a payment processing server from a merchant ecommerce server, via an online computer network, transaction order information regarding a transaction order between a first account holder and the ecommerce merchant, the transaction order information including a transaction identifier and a specified amount;
transmitting from the payment processing server to the first account holder, via an online computer network, identifying information regarding financial account;
receiving by the payment processing server from the banking institution a deposit notification of a physical deposit of currency of the specified amount at the physical location, the deposit notification including information regarding the transaction identifier and the financial account; and
crediting the merchant account by the specified amount.

17. The method of claim 16 further includes
establishing a payment account with the first account holder with the payment processing server.
